(19) United States
(12) Patent Application Publication
(10) Pub. No.: US 2013/0198836 A1
(43) Pub. Date: Aug. 1, 2013

(54) Facial Recognition Streamlined Login

(71) Applicants: Trond WUELLNER, Mountain View, CA (US); Ryan Cairns, Los Altos, CA (US)

(72) Inventors: Trond WUELLNER, Mountain View, CA (US); Ryan Cairns, Los Altos, CA (US)

(73) Assignee: Google Inc., Mountain View, CA (US)

(21) Appl. No.: 13/362,896

(22) Filed: Jan. 31, 2012

(51) Int. Cl. G06F 21/00; G06F 17/30; G06F 7/04

(52) U.S. Cl. 726/19

(57) ABSTRACT

A system and method are disclosed for providing login credentials to a computer system using a biometric indicator. The system includes an image comparison module, a user interface, and an access control module. The image comparison module is configured to compare an image of a user, requesting login access to a client device, with images in a database to determine whether the image matches an image in the database. The user interface is configured to receive input from the image comparison module and to prompt the user for login credentials based on the input received from the comparison module. The access control module is configured to grant or deny login access to the user based on the user input that is entered in response to the prompting.

### BACKGROUND

1. Field

This disclosure relates to systems and methods for providing login credentials for computer systems.

2. Background Art

Passwords are used in many ways to protect data systems and networks. For example, passwords are used to authenticate users of operating systems, applications such as email, remote access, etc. Passwords are also used to protect files and other stored information such as, for example, compressed files, cryptographic keys, or encrypted hard drives. Online transactions such as shopping, banking, communications, and file exchange have become commonplace. Online transactions, however, are susceptible to attack by unscrupulous entities that may intercept passwords or otherwise gain access to login credentials. Identity theft is a consequence of Internet commerce that, unfortunately, is also becoming commonplace. When passwords or identities are stolen, the security of email, online file repositories, bank accounts, etc., may be compromised.

In order to retain high security, it is important for users to use passwords that are sufficiently complex so that they cannot be easily broken and to use a different password for each application requiring a password.

For added security, some applications require multi-factor authentication. Authentication can require several factors such as a password, use of a smart card, or a biometric indicator (e.g., voice recognition, fingerprint, retinal scan, etc.). Single-factor authentication may rely on one of the three forms of authentications, such as a password, while two- or three-factor authentications may use two or three factors, respectively. Although the use of multi-factor authentication increases the difficulty for a third party to gain access to a system, password-based, single-factor authentication is still currently the most commonly used authentication method.

### BRIEF SUMMARY

Systems and methods are disclosed for providing login credentials to a computer system using a biometric indicator for added security and convenience.

In an embodiment, a system is disclosed for providing login credentials to a computer-based system. Such a system is implemented on a processor-based computing device. The system includes an image comparison module, a user interface, and an access control module. The image comparison module is configured to compare an image of a user requesting login access to a client device with images in a database, to determine whether the image matches an image in the database. The user interface is configured to receive input from the image comparison module and to prompt the user for login credentials based on the input received from the comparison module. The input can take the form of a reduced set of login credentials or a complete set of login credentials depending on whether or not a correct match is found. The access control module is configured to grant or deny login access to the user based on the user input that is entered in response to the prompting. The user interface is further configured to prompt the user to enter one of the following based on the result of the comparison: (1) a reduced set of login credentials when a correct match is found, or (2) a complete set of login credentials when no match is found or when an incorrect match is found.

The access control module is further configured to: (1) grant login access to the user when a complete set of login credentials is entered that correspond to an authorized user, (2) grant login access to the user when a reduced set of login credentials is entered that correspond to an authorized user whose image was matched by an image in the database, or (3) deny user login access otherwise.

Further features and advantages as well as the structure and operation of various embodiments are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present invention and together with the description further serve to explain the principles of the invention and to enable a person skilled in the pertinent art(s) to make and use embodiments of the invention.

FIG. 1 is a block diagram of a processor-based computing device in which embodiments of the invention may be implemented.

FIG. 2 is a flowchart illustrating a method of providing login credentials to a system implemented on a processor-based computing device according an embodiment of the invention.

FIG. 3 is flowchart illustrating a method of providing login credentials to a system implemented on a processor-based computing device according to an embodiment of the invention.

FIG. 4 is a schematic illustration of a computer-implemented system for providing login credentials to a computer system implemented according to an embodiment of the invention.

Embodiments are described below with reference to the accompanying drawings. In the drawings, like reference numbers generally refer to identical or functionally similar elements. Additionally, the leftmost digit(s) of a reference number generally identifies the drawing in which the reference number first appears.

### DETAILED DESCRIPTION

This disclosure is directed to systems and methods for providing login credentials to a computer system using a biometric indicator.

It is noted that reference in this specification to “one embodiment,” “an embodiment,” “an example embodiment,” etc., indicate that the embodiment described may include a particular feature, structure, or characteristic, but not every embodiment may necessarily include the particular feature, structure, or characteristic. Moreover, such phrases are not necessarily referring to the same embodiment. Further, when a particular feature, structure, or characteristic, is described in connection with an embodiment, it is submitted that it is within the knowledge of one skilled in the art to effect such feature, structure, or characteristic, in connection with other embodiments whether or not explicitly described.

The following detailed description refers to the accompanying drawings that illustrate exemplary embodiments consistent with this invention. The detailed description is not meant to limit the invention, but rather, the scope of the invention is defined by the appended claims.

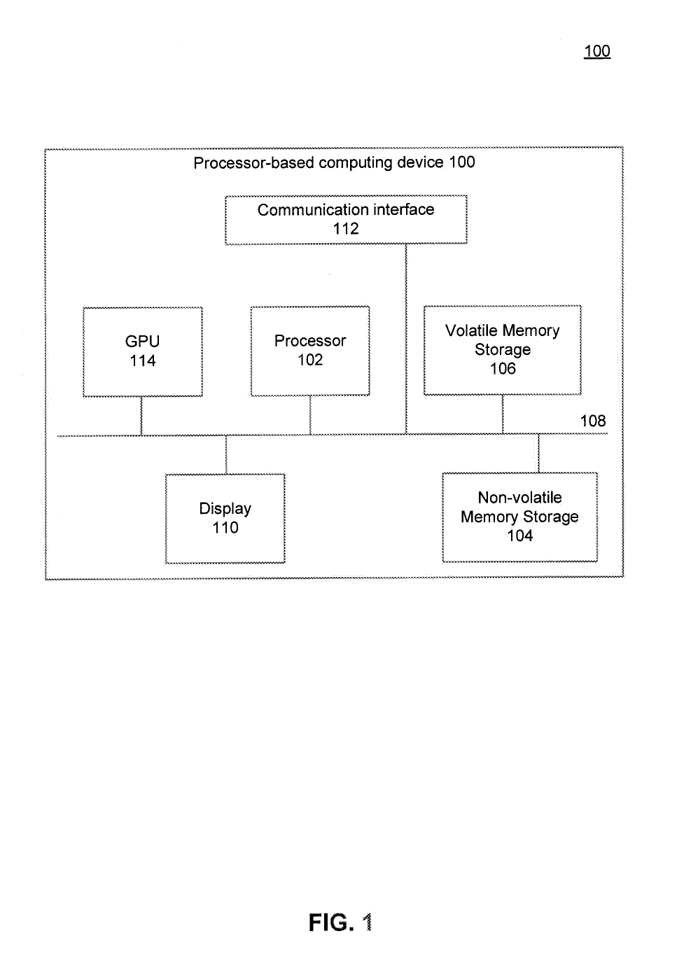

FIG. 1 is an example computer system 100 in which embodiments of the present invention or portions thereof may be implemented as computer readable code. For example, disclosed components or modules may be implemented in one or more computer systems 100 using hardware, software, firmware, tangible computer readable media having instructions stored thereon, or a combination thereof, and may be implemented in one or more computer systems or other processing systems.

A processor-based computing device 100 can include one or more processors 102, one or more nonvolatile storage media 104, one or more memory devices 106, a communication infrastructure 108, a display device 110, and a communication interface 112. Processors 102 can include any conventional or special purpose processors including, but not limited to, digital signal processors (DSP), field programmable gate arrays (FPGA), and application specific integrated circuits (ASIC). A graphics processor unit (GPU) 114 is an example of a specialized processor that executes instructions and programs, selected for complex graphics and mathematical operations, in parallel.

A non-volatile storage device 104 can include one or more of: a hard disk, flash memory, and like devices, that can store computer program instructions and data on computer readable media. One or more of nonvolatile storage devices 104 can be a removable storage device.

Memory devices 106 can include one or more volatile memory devices such as, but not limited to, random access memory (RAM). Communications infrastructure 108 can include one or more device-interconnect buses such as Ethernet, Peripheral Component Interconnect (PCI), and the like.

Typically, computer instructions are executed using one or more processors 102 and can be stored in non-volatile storage media 104, and memory devices 106. A display screen 110 allows results of computer operations to be displayed to a user or an application developer.

A communication interface 112 allows software and data to be transferred between a computer system 100 and external devices. A communication interface 112 can include a modem, a network interface (such as an Ethernet card), a communication port, a PCMCIA slot and card or the like. Software and data transferred via a communication interface 112 can be in the form of signals, which can be electronic, electromagnetic, optical, or other signals, capable of being received by a communication interface 112. These signals can be provided to a communication interface 112 via a communications path. The communication path can carry signals and can be implemented using wire or cable, fiber optics, a phone line, a cellular phone link, an RF link, or other communications channels.

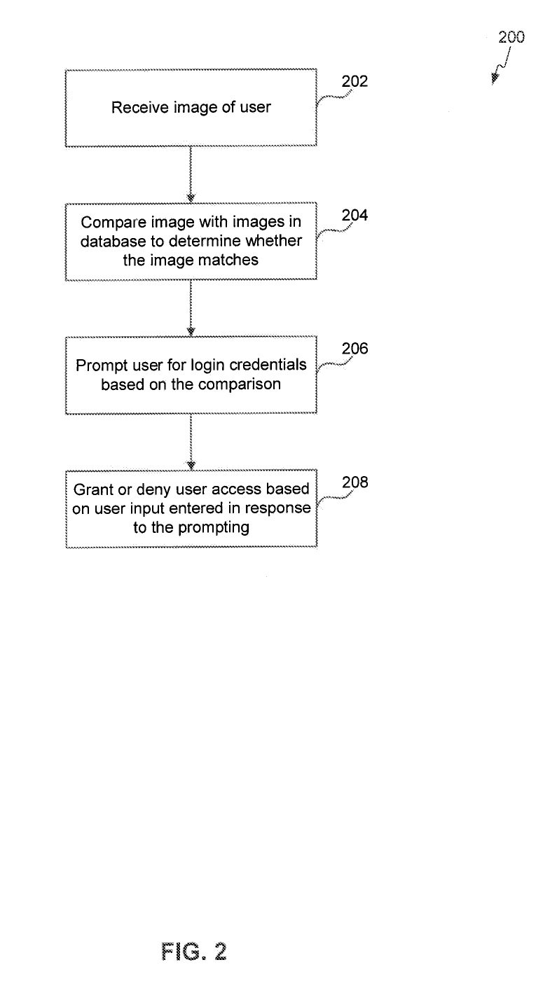

FIG. 2 illustrates a method 200 for providing login credentials to a computer system, the login credentials including a biometric indicator. In this embodiment, the biometric indicator is an image of a user requesting login access to the system. In stage 202, the system receives an image of the user. In stage 204, the image of the user that is received in stage 202 is compared with images in a database to determine whether the image matches one of the images in the database. In stage 206, a user is prompted to enter login credentials based on the comparison. In stage 208, the user is granted or denied login access based on user input entered in response to the prompting.

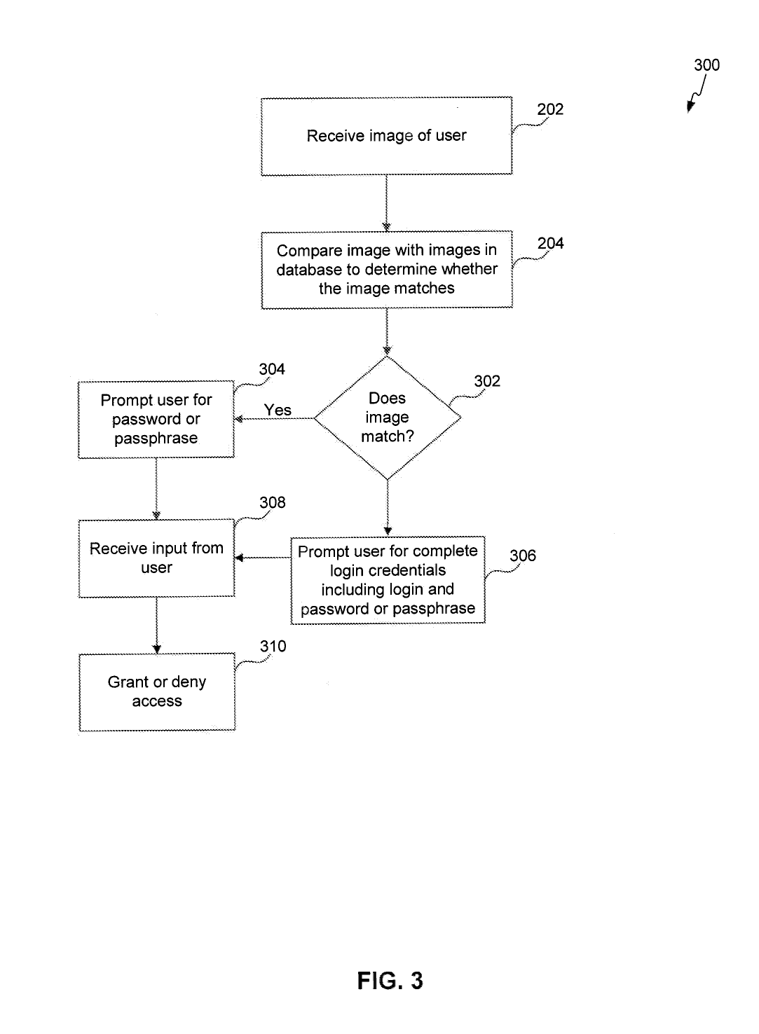

FIG. 3 illustrates a further embodiment method of using a biometric indicator to provide login credentials to a computer system. In stage 202, an image of the user requesting login access is received by the system. In stage 204, the image of the user requesting login access is compared with images in a database to determine whether the image matches. In stage 302, a decision is made whether or not the image matches an image in the database. If the image matches, the user is prompted in stage 304 to enter a password or passphrase. The login name of the user is automatically supplied by the system since the user's image matched a correct user in a database. In stage 308, the system receives input from the user and in stage 310 the system grants or denies access to the user based on the input received from the user in stage 308. in the event that the image does not match an image in the database in stage 302, the user is prompted in stage 306 to supply a complete set of login credentials, including a login name and password or passphrase.

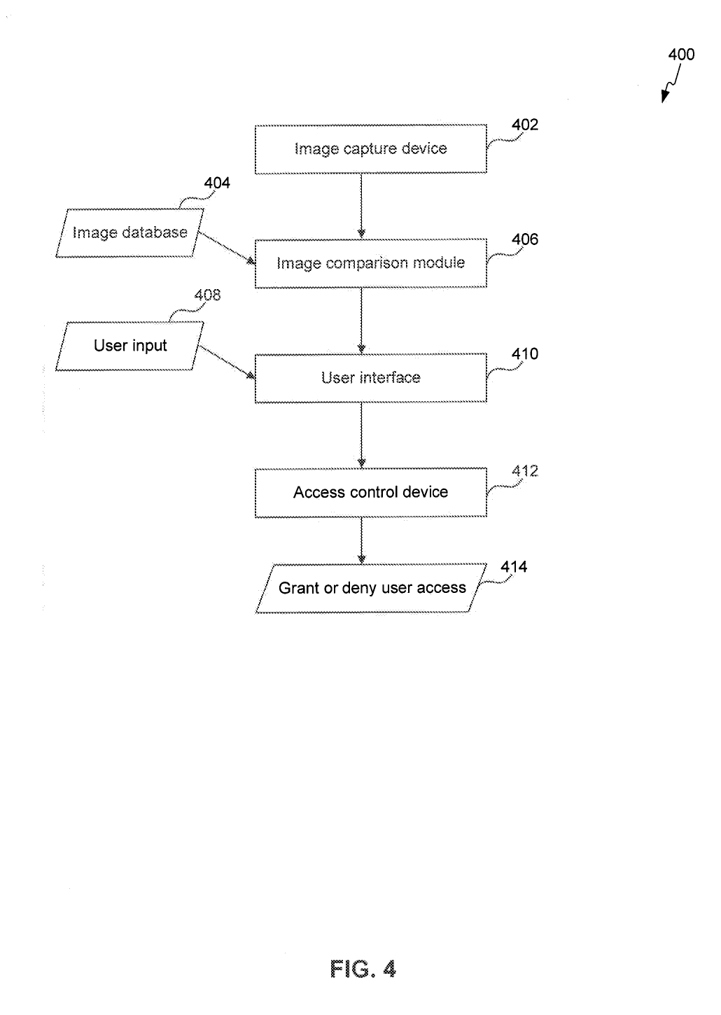

FIG. 4 schematically illustrates a computer-based system 400, implemented on a processor-based computing device 100, for providing login credentials to the computer-based system using a biometric indicator. The system includes an image capture device 402, an image comparison module 406, a user interface 410, and an access control device 412. The image capture device 402 can be any device that can capture an image of a user requesting login access, such as a camera, or webcam. The image comparison module 406 is configured to compare the image of the user, captured by the image capture device 402, with a collection of images in an image database 404. The user interface 410 is configured to accept input from the image comparison module 406 and to accept user input 408 in response to prompting the user, as described above with respects to FIGS. 2-3. The access control device 412 is configured to accept input from the user interface 410 and to either grant or deny user access 414 based on the input from the user interface.

Further implementation details of exemplary systems and methods are provided in the following. In an embodiment, systems can be configured to carry out the methods described above with reference to FIGS. 2 and 3, as the system is being booted up. In another embodiment, systems can be configured to capture an image of a user requesting login access after the system is already up and running.

For the first type of embodiment system, the system can be configured to load image capture software (e.g., webcam drivers) during the system boot process. Early in the boot process, after webcam drivers are loaded, an image of the user can be captured. The system can be configured to then compare the user's image against a collection of potential users to determine a possible match. The collection of potential users can include a group of users who have previously logged into the machine. Significant efficiency is gained by limiting the list of potential users to just those who have previously logged into a particular machine.

A typical user experience of such embodiment systems might be as follows. A user powers up a device, initiating a machine boot up process. When a webcam or other image capture device becomes available, it captures an image of the user. A facial recognition algorithm can then be used to compare the user's image to images of potential users in a database. As a result of the comparison, the system determines whether or not a match is found. The user is then provided with a login form containing several options. When a correct match is found the user can be prompted to enter a password. If the system determines that a match was found, but the match is incorrect, the user is provided with an opportunity to select another user. Upon selecting the correct user, a login form requesting a password would then be provided. The user would then be provided with the opportunity to enter a password. As a third option, in the situation in which no match was found or an incorrect match was found, a user would be provided with the opportunity to enter information for a new user. This third possibility might occur in the situation in which the user is logging onto the system for the first time.

As a fourth option, systems can be configured to login a user automatically. In this situation, no password is required and the user is logged in if the captured image matches an image in the database of potential users.

Embodiments may use facial recognition algorithms to compare the image of a user requesting login access with images in a database. In further embodiments, facial recognition algorithms may be used that compare key features of the image with key features of images in a database. In further embodiments, other biometric indicators may be used to identify a user, such as a retinal scanning. Other biometric indicators can also be used in embodiments to reduce the scope of potential choices for login users. Other examples include fingerprints, body heat signatures, etc.

Embodiments can also be directed to computer program products comprising software stored on any computer readable medium. Such software, when executed in one or more data processing devices, causes a data processing device to operate as described herein. Embodiments of the invention can employ any computer useable or readable medium. Examples of computer readable mediums include, but are not limited to, primary storage devices (e.g., any type of random access memory), secondary storage devices (e.g., hard drives, floppy disks, CD ROMs, ZIP disks, tapes, magnetic storage devices, optical storage devices, MEMs, nanotechnological storage devices, etc.).

Typically, computer instructions are executed using one or more processors 102 and can be stored in a non-volatile storage medium 104 or memory device 106. Computer instructions can be stored on a client or web server in a compiled file, an executable file, or a dll library. Computer instructions can also be compiled on a client prior to execution. Computer instructions can also be included in a routine, a subroutine, or layers of a software stack that are manipulated by processors 102.

Embodiments have been described above with the aid of functional building blocks illustrating the implementation of specific functions and relationships thereof. The boundaries of these functional building blocks have been arbitrarily defined herein for the convenience of the description. Alternate boundaries can be defined so long as the specific functions and relationships thereof are appropriately performed.

The foregoing description of the specific embodiments will so fully reveal the general nature of the invention that others can, by applying knowledge within the skill of the art, readily modify and/or adapt for various applications, such specific embodiments without undue experimentation, without departing from the general concept of the present invention. Therefore, such adaptations and modifications are intended to be within the meaning and range of equivalents of the disclosed embodiments based on the teachings and guidance presented herein. It is to be understood that the phraseology or terminology herein is for the purpose of description and not of limitation, such that the terminology or phraseology of the present specification is to be interpreted by the skilled artisan in light of the teaching and guidance presented herein.

The Summary and Abstract sections may set forth one or more but not all exemplary embodiments of the present invention as contemplated by the inventors, and thus, are not intended to limit the present invention and appended claims in any way.

The breadth and scope of the present invention should not be limited by any of the above described exemplary embodiments, but rather, should be defined only in accordance with the following claims and their equivalents.

What is claimed is:

1. A computer implemented method, comprising:
receiving, by a computational device, an image of a user requesting login access to a client device;
comparing, by the computational device, the image with images of authorized users in a database to determine whether the image matches an image in the database;
prompting the user to enter login credentials based on the comparing, wherein the prompting comprises requesting the user to enter one of the following based on the result of the comparing:
a reduced set of login credentials when a correct match is found; or
a complete set of login credentials when no match is found or when an incorrect match is found; and
granting or denying the user login access based on the login credentials entered by the user.

2. The method of claim 1, wherein the prompting comprises requesting the user to confirm or deny that a correct match has been found.

3. The method of claim 1, wherein the comparing comprises using a facial recognition algorithm to compare the image with images in a database.

4. The method of claim 3, wherein the comparing comprises using a facial recognition algorithm to compare key features of the image with key features of images in a database.

5. The method of claim 1, further comprising:
granting the user login access when a complete set of login credentials is entered that correspond to an authorized user;
granting the user login access when a reduced set of login credentials is entered that corresponds to the authorized user whose image in the data base was matched by the image of the user that is requesting login access; or
denying the user login access otherwise.

6. A computer readable storage medium having program instructions stored thereon that, when executed by a processor, cause the processor to grant or deny login access, the program instructions comprising computer readable code that causes a computer to:
receive an image of a user requesting login access to a client device;
compare the image with images of authorized users in a database to determine whether the image matches an image in the database;
prompt the user to enter login credentials based on the comparing, wherein the prompting comprises requesting the user to enter one of the following based on the result of the comparing:
a reduced set of login credentials when a correct match is found; or a complete set of login credentials when no match is found or when an incorrect match is found; and
grant or deny the user login access based on the login credentials entered by the user.

7. The computer readable storage medium of claim 6, wherein the program instructions further comprise computer readable code that causes the computer to prompt the user to confirm or deny that a correct match has been found.

8. The computer readable storage medium of claim 6, wherein the program instructions further comprise computer readable code that causes the computer to use a facial recognition algorithm to compare the image with images in a database.

9. The computer readable storage medium of claim 8, wherein the program instructions farther comprise computer readable code that causes the computer to use a facial recognition algorithm to compare key features of the image with key features of the images in a database.

10. The computer readable storage medium of claim 6, wherein the program instructions further comprise computer readable code that causes the computer to:
grant the user login access when a complete set of login credentials is entered that correspond to an authorized user;
grant the user login access when a reduced set of login credentials is entered that corresponds to the authorized user whose image in the data base was matched by the image of the user that is requesting login access; or
deny the user login access otherwise.

11. A computer implemented system, comprising:
an image comparison module configured to compare an image of a user requesting login access to a client device, with images in a database to determine whether the image matches an image in the database;
a user interface configured to receive input from the image comparison module and to prompt the user for login credentials based on the input received from the comparison module, wherein the prompting comprises requesting the user to enter one of the following based on the result of the comparing:
a reduced set of login credentials when a correct match is found; or
a complete set of login credentials when no match is found or when an incorrect match is found; and
an access control module configured to grant or deny the user login based on user input that is entered in response to the prompting.

12. The system of claim 11, wherein the user interface is further configured to prompt the user to confirm or deny that a correct match has been found.

13. The system of claim 11, wherein the image comparison module is further configured to use a facial recognition algorithm to compare the image with images in the database.

14. The system of claim 13, wherein the image comparison module is further configured to use a facial recognition algorithm to compare key features of the image with key features of images in the database.

15. The system of claim 11, wherein the image comparison module is further configured to update image comparison criteria based on user input when an incorrect match is found.

16. The system of claim 11, wherein the access control module is further configured to:
grant the user login access when a complete set of login credentials is entered that correspond to an authorized user;
grant the user login access when a reduced set of login credentials is entered that corresponds to the authorized user whose image in the data base was matched by the image of the user that is requesting login access; or
denying the user login access otherwise.

17. The system of claim 11, further comprising an image capture device that is configured to capture an image of the user as part of the system boot process.
